(19) United States
(12) Patent Application Publication
(10) Pub. No.: US 2005/0194160 A1
(43) Pub. Date: Sep. 8, 2005

(54) Tine for a soil cultivating implement

(76) Inventors: Lindsay Peter Thian, Southbridge (NZ); Karen Isabelle Thian, Southbridge (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 11/066,723

(22) Filed: Feb. 24, 2005

(30) Foreign Application Priority Data
Feb. 24, 2004 (NZ) 531359

(51) Int. Cl. A01B 33/00

(52) U.S. Cl. 172/705

(57) ABSTRACT

A one-piece tine for a soil cultivating implement includes a spring portion which connects a mounting portion to a shank portion. The longitudinal centreline of the tine lies substantially in a plane of the tine. The spring portion is arcuate having a re-entrant portion at a first end thereof, the cross section of the spring portion being relatively thin in the plane of the tine and elongate perpendicular to the plane of the tine. The mounting portion is fixed to the re-entrant portion and is adapted for mounting the tine to the apparatus. The shank portion has a foot for receiving a ground-engaging point, and the cross section of the shank portion is elongate in the plane of the tine to provide a blade-like shape for improved debris clearance.

### RELATED APPLICATIONS

This application claims the benefit of the New Zealand Patent Application Number 531359 filed Feb. 24, 2004.

### BACKGROUND OF THE INVENTION

1. Field of the Invention

This invention relates to tines for soil cultivating implements which, for example, are intended to be coupled to the rear of a tractor for carrying out different cultivating operations such as preparation of a seedbed or direct seed drilling.

2. Description of the Related Art

Spring tines are used on soil cultivating implements, such as harrows, cultivators, direct drilling machines or the like, and are provided with a curved spring section whose upper end is designed for the fastening to the implement and a lower end or shank which receives a point, such as harrow tips, ploughshares or the like. The points on the spring tines enter into the soil and loosen it, and tend to break down clods into smaller fragments. If a point encounters a solid obstacle in the ground, the spring section allows the tine to be elastically deformed, thereby allowing the point to move around the obstacle and avoiding the application of shock loads to the cultivator. The term “soil cultivating implement” as used herein includes cultivators and direct drilling machines and the tine and tine assembly according to the invention may be provided on soil cultivating implements of the type which are intended to be used either before or after previous working of the soil.

So-called S-tines are commonly used in soil cultivating implements and are named for their shape, the longitudinal centreline of the tine being formed in an S-shape which lies in a plane (referred to herein as the plane of the tine). S-tines are generally bent from a length of bar having an unvarying rectangular cross section with pairs of opposing long and short sides, the long sides extending perpendicular to the plane of the tine. One problem with these existing tines is their tendency to accumulate debris (known as trash) which includes clumps of plant material and stubble. This problem can be severe on direct drilling machines which introduce seed directly into previously unworked soil i.e. after harvesting of a previous crop, and when there will be stubble and plant residuals remaining anchored in the soil surface. This debris build-up can affect the proper operation of the tines and results in repeated stoppages in the cultivation operation to clear this debris. It would be advantageous to provide an improved tine providing more efficient debris clearance and which may be fitted to cultivators and seed drills and the like.

Another drawback of these prior art S-tines relates to their geometry when installed on a machine. The lower shank of the tine is inclined forward and when the point strikes an obstacle and is deflected backwards, this geometry causes the point to be pushed more deeply into the soil, thereby tending to further increase the loads acting to deflect the tine and perhaps overload the tine.

Multiple tines are used on cultivators, and they are designed to have a high strength-to-weight ratio. However parts of the tine are highly stressed and they do crack and break after repeated harsh use. To avoid the danger of breaking, different approaches have been tried in the prior art spring tines including reinforcing the spring portion by means of a second spring portion or increasing the thickness of the rectangular bar from which the tine is formed. U.S. Pat. No. 4,534,418 describes an S-tine intended to address this problem by reinforcing the section of the spring portion where the greatest bending moment is present. The reinforcement is provided by a localised increase in the cross-sectional area of the tine i.e. an increase in thickness with the width remaining constant, or vice versa. With this design however, the tine cannot be formed from plain bar stock without a costly initial manufacturing step to provide this increased cross-sectional area.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country. It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### SUMMARY OF THE INVENTION

According to one aspect of the present invention there is provided an elongate one-piece tine for a soil cultivating implement, wherein the longitudinal centreline of the tine lies substantially in a plane of the tine, the tine including:
an arcuate spring portion having a re-entrant portion at a first end thereof, the cross section of the spring portion being relatively thin in the plane of the tine and elongate perpendicular to the plane of the tine;
a mounting portion fixed to the re-entrant portion and adapted for mounting the tine to the implement;
a shank portion having a foot for receiving a ground-engaging point, the shank portion being fixed to a second end of the spring portion;
characterised in that the cross section of the shank portion is elongate in the plane of the tine.

It has been found that the resulting blade-like shape of the shank portion provides more efficient debris clearance.

Preferably the cross section of the shank portion includes opposing long sides which are substantially parallel to the plane of the tine. In an alternative embodiment the long sides of the cross section may be curved or inclined to one another.

Preferably the opposing long sides of the cross section are joined by a pair of opposing short sides which in use form leading and trailing sides of the tine. The short sides may be parallel or curved or inclined to one another. In an alternative embodiment the long sides of the cross section may join at at least one edge, i.e. at least one of the short sides approaches zero length.

Preferably the bend of the spring portion is a C-shaped reflex bend and the re-entrant portion has a radius of curvature smaller than the radius of curvature of any other part of the spring portion. The shank portion preferably includes a substantially straight elongate lower portion at one end of which the foot is provided. At the end of the straight lower portion opposing the foot, a curved knee portion is provided. Preferably a longitudinal centreline of the lower portion is substantially perpendicular to a longitudinal centreline of the mounting portion.

The longitudinal centreline of the tine is preferably smoothly continuous with adjacent portions of varying curvature joining one another tangentially.

Preferably a transition portion of the shank joins the knee portion to the spring portion, the cross sectional shape of the in the transition portion changing smoothly and continuously.

Preferably the cross-sectional area of the tine is substantially constant throughout its length and the thickness of the re-entrant portion measured in the plane of the tine is greater than the thickness of any other part of the spring portion measured in the plane of the tine.

In a first embodiment, the foot portion has an aperture for receiving a fastener for directly fixing the point. In an alternative embodiment, the foot portion has a cross section with a major axis substantially perpendicular to that of the leg portion and is adapted for receiving a mounting clip for a knock-on point.

According to another aspect of the present invention, there is provided a tine assembly including a tine substantially as described above and further including a seed supply tube detachably fixed to the shank portion. In the first embodiment the seed tube is fixed by fasteners through holes in the lower leg portion. In the alternative embodiment, the lower end of the seed tube includes an opening adapted to receive the foot to the tine for securing the seed tube.

According to another aspect of the present invention, there is provided a soil cultivating implement including a tine substantially as described above. The shank portion of the tine includes a substantially straight elongate lower portion at one end of which the foot is provided, and this straight lower portion extends generally upright in use when the tine is drawn through the ground.

This invention provides a tine which is effective and efficient in operational use, which reduces operating costs, and which is less prone to breakage. Both with and without the seed delivery tube, the tine and tine assembly have a shape that more efficiently clears debris. The tine and tine assembly may be economically constructed and has a design which minimizes manufacturing costs, maximizes performance and simplifies maintenance by offering a reduced number of parts.

### BRIEF DESCRIPTION OF THE DRAWINGS

Further aspects of the present invention will become apparent from the following description which is given by way of example only and with reference to the accompanying drawings in which:

FIG. 1 is a side elevation of one embodiment of a tine;

FIGS. 2a, 2b and 2c are cross sections through the tine at AA, BB and CC respectively, as shown on FIG. 1;

FIG. 3 is a pictorial view of the tine of FIG. 1;

FIG. 4 is a side elevation of an alternative tine foot;

FIG. 5 is a pictorial view of the foot of FIG. 4;

FIG. 6 is a side elevation of another embodiment of tine assembly;

FIG. 7a is a side elevation of the foot of FIG. 6

FIG. 7b is a section through the foot of FIG. 7a;

FIG. 8a is a side elevation of the alternative foot of FIG. 2, and

FIG. 8b is a section through the foot of FIG. 8a.

### DETAILED DESCRIPTION OF THE PREFERRED EMBODIMENT

Referring to FIGS. 1 and 4, a first embodiment of a tine 10 according to the present invention is made from cold-forged steel, although other materials and manufacturing methods are contemplated. Tine 10 is shown together with a three mutually orthogonal reference axes X, Y and Z, wherein axis Y is a vertical plumb line and the longitudinal centreline 50 lies generally in the plane of the tine (the XY plane).

Tine 10 is formed from an elongate bar with a varying cross sectional shape but a substantially constant cross-sectional area throughout its length. The tine 10 includes a shank portion 14, a spring portion 15, and a mounting portion 16.

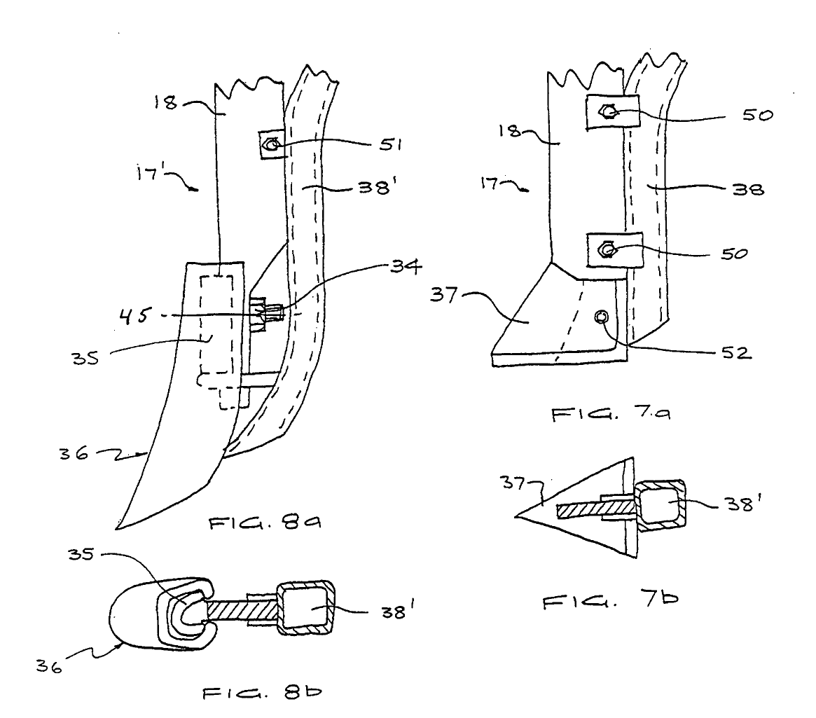

Shank portion 14 includes a lowermost foot 17 for receiving a ground-engaging point (described below with reference to FIGS. 7a and 7b), a straight lower portion 18, a curved knee portion 19 and a first transition portion 21. The cross section of the shank portion 14 is elongate in the plane of the tine and relatively thin perpendicular to the plane of the tine, providing a blade-like shape for more efficient debris clearance.

Spring portion 15 resiliently connects the shank portion 14 to the mounting portion 16 in a C-shaped reflex bend. Spring portion 15 includes a re-entrant portion 25 and adjacent second transition portion 22. As seen in FIGS. 1 and 3 the cross section of the spring portion 15 is relatively thin in the plane of the tine and elongate perpendicular to the plane of the tine (in the Z direction). The re-entrant portion 25 connects a substantially straight mounting portion 24 to the spring portion 16 at a re-entrant angle. The smallest radius of curvature of the spring portion 15 in the plane of tine is in the re-entrant portion 25.

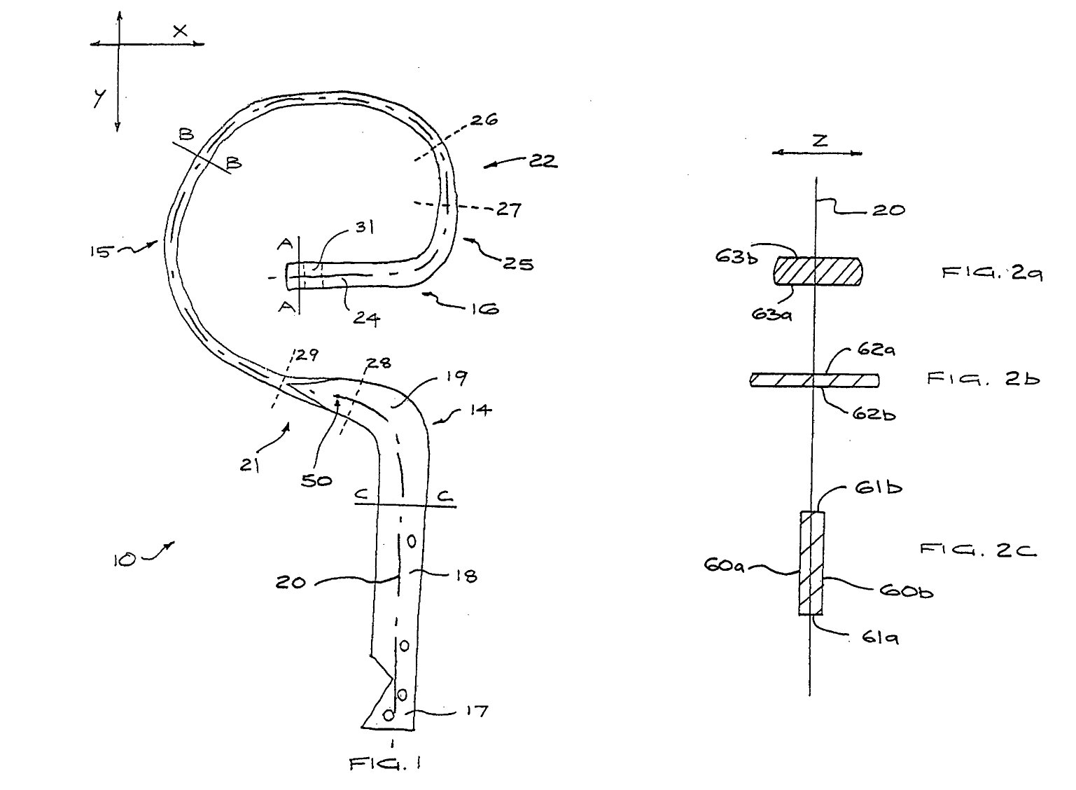

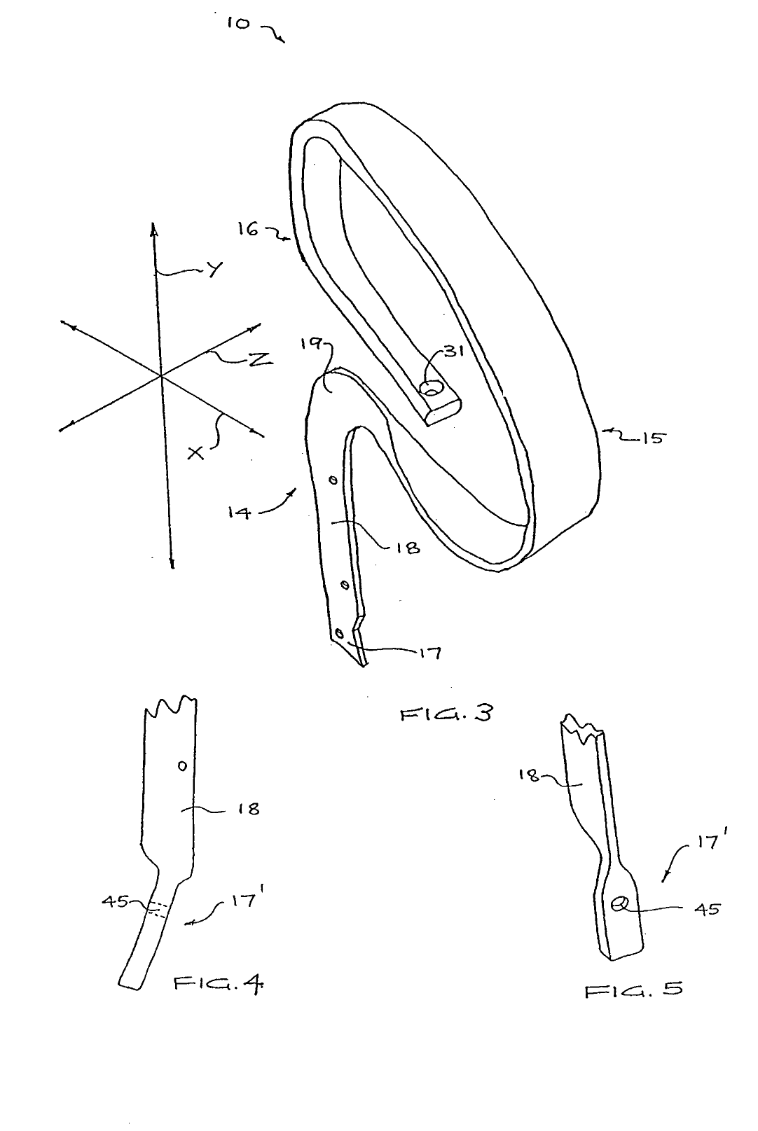

FIGS. 2a-2c show the variation in cross section of the tine 10 with respect to longitudinal centre line 20 (which lies in the plane of the tine) and the Z axis (perpendicular to the plane of the tine). The cross sections of FIG. 2a, FIG. 2b and FIG. 2c correspond to the sections AA, BB and CC respectively. The tine 10 may be forged from bar, such as round stock and each cross section is symmetrical about the centreline 20. The cross section of the shank portion 14 includes opposing long sides 60a, 60b which are substantially parallel to the plane of the tine and joined by short sides 61a, 61b. The cross sections of the mounting portion 16 and spring portion 15 have opposing long sides 62a, 62b and 63a, 63b respectively which are substantially perpendicular to the long sides 60a, 60b on the shank portion 14.

In the transition portions 21, 22 the shape of the cross section is smoothly varied e.g. increasing the thickness while the width is reduced. The first transition portion 21 between the knee portion 19 and the rest of the spring portion 15 extends between sections 28 and 29. In this transition portion 21 a point of inflection 50 is provided in the longitudinal centreline 20. The second transition portion 22 lies between the spring portion 15 and the re-entrant portion 25 (between sections 26 and 27). The beginning of the transition at section 27 preferably starts at a point where the radius of curvature of the re-entrant curve is reduced. The dimensions of the cross section of the mounting portion 16 and re-entrant portion 25 are constant until section 27.

As will be apparent from the geometry shown, the cross sections FIG. 2a, FIG. 2b and FIG. 2c vary in stiffness and ability to resist bending moments applied in use (generally about the Z axis). The stiffness of the spring portion being less than that of the mounting portion 16 and considerably less than that of the shank portion 14 means the spring portion 15 deflects to a greater extent under load, acting as a spring and providing the greater part of the resilience of the tine 10.

This arrangement provides a seed drill/tine which is relatively narrow (measured in the Z direction) and also having a relatively short length (measured in the X direction). It has been found that this shape more efficiently clears the debris in use.

The thickness of the re-entrant portion 25 measured in the plane of the tine is greater than the thickness of any other part of the spring portion measured in the plane of the tine. This effectively reinforces this relatively sharp and highly stressed re-entrant curve. The mounting portion 24 is generally horizontal (parallel to axis X) and includes a hole 31 for receiving a fastener to fix the mounting portion 24.

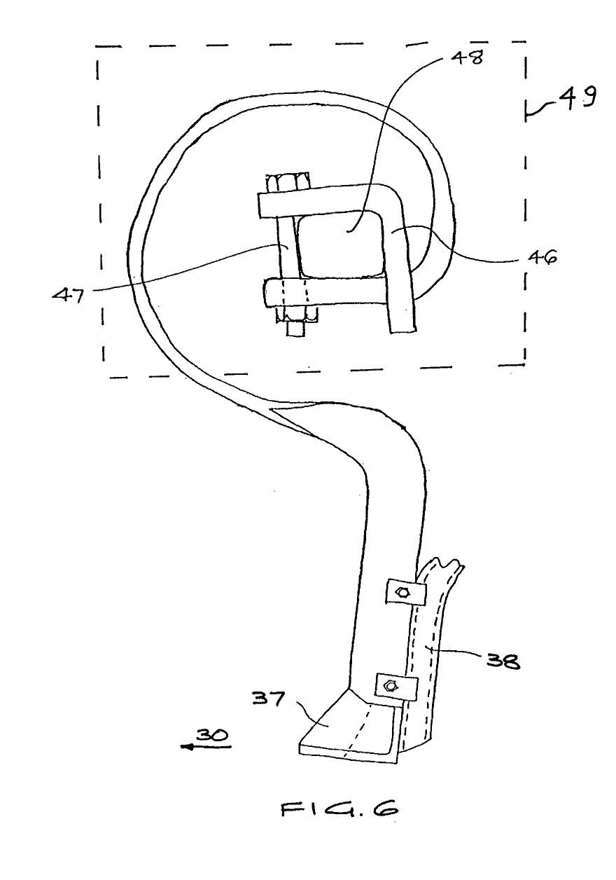

FIGS. 4 and 5 illustrate an alternative embodiment of the foot 17′, the foot 17′ has a cross section with a major axis substantially perpendicular to that of the leg portion 18 and is adapted for holding a mounting clip (see FIG. 8a) for a knock-on point secured by a fastener 34 through the aperture 45.

As shown in FIG. 6, a clamp 46 and a fastener 47 are used to fix the tine assembly in a cantilevered manner to the frame member 48 of a soil cultivating implement 49. In use the point 37 is drawn forward through the ground in direction 30 and this action applies a bending moment to the tine generally about the Z axis. The straight lower portion 18 of the tine deflects to extend substantially upright when drawn through the ground in use. This geometry causes the point to be raised (rather than pushed more deeply into the soil) when the point strikes an obstacle in the ground and is deflected backwards, thereby tending to decrease the loads acting to deflect the tine and perhaps avoiding overload of the tine. It will be understood that when not in use, the straight lower portion 18 is slightly inclined from the upright, the point 37 being slightly offset in direction 30.

Referring to FIGS. 7a, 7b, 8a and 8b two different feet 17, 17′ are illustrated for receiving different types of tip or point. Foot 17′ has an aperture 45 for receiving a bolt 34 for securing a so-called “Marlow” clip 35, for holding a Marlow knock-off type point 36. Foot 17 is adapted to receive a point 37 fixed by a fastener, such as a roll pin 52.

For seed drilling, seed supply tubes 38, 38′ are fixed to the tines extending upward from behind the point 36, 37 adjacent to the lower shank 18. In this manner, although the length of the cross section (measured in the X direction) is longer, it retains a relatively short length, compared to prior designs.

The seed tube 38 is fixed by fasteners 50 through holes in the lower leg portion 17. The lower end of the seed tube 38′ includes an opening adapted to receive the end of foot 17′ and the upper end of the seed tube 38′ is fixed by fastener 51 to the shank portion 18.

Aspects of the present invention have been described by way of example only and it should be appreciated that modifications and additions may be made thereto without departing from the scope thereof.

1. An elongate one-piece tine for a soil cultivating implement, wherein the longitudinal centreline of the tine lies substantially in a plane of the tine, the tine including:
an arcuate spring portion having a re-entrant portion at a first end thereof, the cross section of the spring portion being relatively thin in the plane of the tine and elongate perpendicular to the plane of the tine;
a mounting portion fixed to the re-entrant portion and adapted for mounting the tine to the implement;
a shank portion having a foot for receiving a ground-engaging point, the shank portion being fixed to a second end of the spring portion;
characterised in that the cross section of the shank portion is elongate in the plane of the tine.

2. The tine of claim 1 wherein the cross section of the shank portion includes opposing long sides which are substantially parallel to the plane of the tine

3. The tine of claim 1 wherein the bend of the spring portion is a C-shaped reflex bend and the re-entrant portion has a radius of curvature smaller than the radius of curvature of any other part of the spring portion.

4. The tine of claim 1 wherein the shank portion includes a substantially straight elongate lower portion at one end of which the foot is provided and at the end of the straight lower portion opposing the foot, a curved knee portion is provided.

5. The tine of claim 1 wherein a longitudinal centreline of the lower portion is substantially perpendicular to a longitudinal centreline of the mounting portion.

6. The tine of claim 1 wherein the longitudinal centreline of the tine is smoothly continuous with adjacent portions of varying curvature joining one another tangentially.

7. The tine of claim 1 wherein a transition portion of the shank joins the knee portion to the spring portion, the cross sectional shape of the in the transition portion changing smoothly and continuously.

8. The tine of claim 1 wherein the cross-sectional area of the tine is substantially constant throughout its length and the thickness of the re-entrant portion measured in the plane of the tine is greater than the thickness of any other part of the spring portion measured in the plane of the tine.

9. The tine of claim 1 wherein the cross-sectional area of the tine is substantially constant throughout its length, the cross section of the shank portion includes opposing long sides which are substantially parallel to the plane of the tine, the bend of the spring portion is a C-shaped reflex bend, the re-entrant portion has a radius of curvature smaller than the radius of curvature of any other part of the spring portion, the shank portion includes a substantially straight elongate lower portion at one end of which the foot is provided and at the end of the straight lower portion opposing the foot, a curved knee portion is provided, a longitudinal centreline of the lower portion is substantially perpendicular to a longitudinal centreline of the mounting portion, the longitudinal centreline of the tine is smoothly continuous with adjacent portions of varying curvature joining one another tangentially, and wherein a transition portion of the shank joins the knee portion to the spring portion, the cross sectional shape of the in the transition portion changing smoothly and continuously, and the thickness of the re-entrant portion measured in the plane of the tine is greater than the thickness of any other part of the spring portion measured in the plane of the tine.

10. The tine of claim 1 wherein the foot portion has a cross section with a major axis substantially perpendicular to that of the leg portion and is adapted for receiving a mounting clip for a knock-on point.

11. The tine of claim 1, further comprising a seed supply tube detachably fixed to the shank portion.

12. The tine of claim 11 wherein the seed tube is fixed by fasteners through holes in the lower leg portion.

13. The tine assembly of claim 11 wherein the lower end of the seed tube includes an opening adapted to receive the foot to the tine for securing the seed tube.

14. A soil cultivating implement comprising one or more elongate one-piece tines, wherein the longitudinal centreline of the tine lies substantially in a plane of the tine, the tine including:
an arcuate spring portion having a re-entrant portion at a first end thereof, the cross section of the spring portion being relatively thin in the plane of the tine and elongate perpendicular to the plane of the tine;
a mounting portion fixed to the re-entrant portion and adapted for mounting the tine to the implement;
a shank portion having a foot for receiving a ground-engaging point, the shank portion being fixed to a second end of the spring portion characterised in that the cross section of the shank portion is elongate in the plane of the tine.

15. The soil cultivating implement of claim 14 wherein the shank portion of the tine includes a substantially straight elongate lower portion at one end of which the foot is provided, the straight lower portion being adapted to extend generally upright in use when the tine is drawn through the ground.

16. The soil cultivating implement of claim 14, further comprising a seed supply tube detachably fixed to the shank portion of at least one tine.

17. The soil cultivating implement of claim 14, wherein the tines are configured to attach to replaceable knock-on points.
